(19) United States
(12) Patent Application Publication
(10) Pub. No.: US 2012/0050334 A1
(43) Pub. Date: Mar. 1, 2012

(54) DISPLAY APPARATUS AND A METHOD THEREFOR

(75) Inventors: Leo Jan Velthoven, Eindhoven (NL); Guido Theodorus Gerardus Volleberg, Eindhoven (NL); Mark Jozef Willem Mertens, Eindhoven (NL)

(73) Assignee: KONINKLIJKE PHILIPS ELECTRONICS N.V., EINDHOVEN (NL)

(21) Appl. No.: 13/320,052

(22) PCT Filed: May 6, 2010
(86) PCT No.: PCT/IB2010/052001

§ 371 Date: Nov. 11, 2011

(30) Foreign Application Priority Data
May 13, 2009 (EP) 09160124.5

(51) Int. Cl. G09G 5/00; G06K 9/32

(52) U.S. Cl. 345/660; 382/298

(57) ABSTRACT

A display apparatus for presenting an image comprises an image receiver (101) for receiving an image to be displayed. An image analyzer (103) performs a local image profile analysis on at least a first region of the image to determine a pixel value spatial variation characteristic. The image analyzer (103) is coupled to a scaling processor (105) which scales at least a second region of the image in response to the pixel value spatial variation characteristic. The scaling processor (105) is coupled to a presentation controller (107) which presents the scaled image. The scaling may specifically be adjusted dependent on a sharpness or spatial frequency characteristics of the image. The invention may allow an improved adaptation of the presentation of one or more images to the specific characteristics of the image(s).

### FIELD OF THE INVENTION

The invention relates to a display system and in particular, but not exclusively, to display systems for presenting one or more images in large size display windows.

### BACKGROUND OF THE INVENTION

There is currently a trend for many image displays to increase in size. For example, television displays are continuously increasing in size and displays of 42 inch are currently common with even larger displays of e.g. 60 inches being generally available. Indeed, it is expected that in the future very large display panels, e.g. covering most of a wall, may become widespread. Also, very large display windows are often achieved using image projecting devices that can project a display on a surface of another object such as e.g. a wall, a reflective screen etc.

Furthermore, at the same time as the size of typical displays is increasing, the variety in the characteristics of the content to be displayed is increasing substantially. For example, a given display may be used for Standard Definition (SD) television, for High Definition (HD) television, for Quad Definition (QD) video for very high resolution computer displays (e.g. gaming), for low quality video sequences (such as e.g. web based video content at low data rates or mobile phone generated video) etc.

The increased variety and sizes of displays and the increased variety in the quality and resolution of the source content makes it increasingly important and critical to adapt the display system to the specific current characteristics of both the display and content in order to optimize the user experience.

One approach that has been proposed is to upscale the received content to the resolution of the display. For example, an HD television can upscale an SD video signal to the HD resolution of the display and present this upscaled version. However, although such an approach may provide an attractive picture in many scenarios, it also has some associated disadvantages. In particular, the presented image will in many scenarios be perceived to be of relatively low quality either due to the original source quality or due to quality degradations associated with the upscaling process.

Indeed, for many large size displays with high resolution, the source content will often be the limiting factor for the perceived image quality. For example, a standard definition picture displayed on a 60 inch television will typically be perceived to be of relatively low quality. Indeed this is often the case even if upscaling is applied as this introduces noise and gives the perception of an unsharp image. Even state of the art picture quality processing algorithms such as peaking, color transient improvement, color enhancement, noise reduction, digital artifacts reduction etc. are typically not able to sufficiently mitigate the introduced noisy and unsharp impression of the upscaled material.

Hence, an improved display system would be advantageous and in particular a system allowing increased flexibility, an improved perceived quality, an improved user experience, facilitated operation, facilitated implementation and/or improved performance would be advantageous.

### SUMMARY OF THE INVENTION

Accordingly, the invention seeks to preferably mitigate, alleviate or eliminate one or more of the above mentioned disadvantages singly or in any combination.

According to an aspect of the invention there is provided a display apparatus for presenting an image, the display apparatus comprising: means for receiving an image to be displayed; analyzing means for performing a local image profile analysis on at least a first region of the image to determine a characteristic representing spatial variation of pixel values; scaling means for scaling at least a second region of the image in response to the pixel value spatial variation characteristic; and presentation means for presenting the scaled image.

The invention may allow an improved presentation of one or more images. In particular, a geometric characteristic, such as a display window size, for an image may be adjusted to match the spatial variation characteristics of the image being presented. The invention may in many embodiments allow an improved adaptation to a large number of different types of image signals and signal sources. In particular, the approach may allow an adaptation of the display window size to the sharpness or quality of the image. In particular, the invention may allow an optimization based not merely on a pixel resolution of the image but rather allows this optimization to depend on the actual quality of the image itself. For example, different images with the same resolution may be scaled differently depending on the actual sharpness of the image within that resolution. In particular, the scaling may be different for images that are originally generated at the resolution and images that are upscaled to result in the specific resolution. The invention may for example allow a displayed size of the image to be dependent on the (current or original) visual quality of the image. Thus, rather than merely scaling the image to fit the specific display size resulting in a given perceived quality, the invention may in some embodiments allow the scaling (e.g. the size, or scaling algorithm kind) of the image to be adjusted to provide the desired perceived quality.

The image may be an image of a sequence of images, such as an image of a video signal. The pixel values may for example be luminance and/or colour values.

The image may be a prescaled image. For example, the display apparatus may comprise a prescaler which scales an input image to a given resolution. E.g. the prescaler may be adapted to scale different input images with different resolutions to the same predetermined/fixed resolution. The analysis may accordingly be performed on an image with a known predetermined/fixed resolution, however with a particular visual quality. The prescaled image may then be scaled in the scaling means to provide the desired characteristic (e.g. size) suitable for the specific pixel value spatial variation characteristic. The predetermined/fixed resolution may specifically correspond to a maximum resolution of a display on which the image is presented.

In some cases, the analysis means may comprise a prescaler that prescales the image to a predetermined/fixed resolution. The analysis may accordingly be performed on an image with a known predetermined/fixed resolution. However, the scaling may be performed on the image prior to the prescaling, i.e. to the image at the original resolution. The adaptation of the scaling may accordingly take into account the difference between the resolution of the prescaled and the original image.

In accordance with an optional feature of the invention, the analyzing means is arranged to perform a spatial frequency analysis of local spatial frequencies on at least the first region and to generate the pixel value spatial variation characteristic to comprise a spatial frequency characteristic.

This may provide particularly advantageous performance. In particular, it may provide a low complexity yet accurate indication of a sharpness (and/or signal complexity and/or visual quality/correctness/beauty/detail) of the underlying image and may provide a particularly suitable parameter on which to base the optimization of the scaling of the image.

The spatial frequency analysis may be performed directly on the image or on a modified version of the image. For example, the spatial frequency analysis may be performed on an upscaled/prescaled version of the image. The spatial frequency characteristics may be indicative of a spatial frequency of the image that will be presented if no scaling is applied.

In accordance with an optional feature of the invention, the analyzing means is arranged to perform a sharpness analysis on at least the first region and to generate the pixel value spatial variation characteristic to comprise a sharpness characteristic.

This may provide a particularly advantageous performance and image presentation. In particular, it may in many scenarios allow a size of the displayed image to be optimized for the specific characteristics of the image.

In accordance with an optional feature of the invention, the analyzing means is arranged to perform a texture analysis on at least the first region and to generate the pixel value spatial variation characteristic to comprise a texture characteristic.

This may provide a particularly advantageous image presentation and/or may facilitate analysis.

In accordance with an optional feature of the invention, the analyzing means is arranged to perform a pixel value distribution analysis on at least the first region and to generate the pixel value spatial variation characteristic to comprise a pixel value distribution characteristic.

This may provide a particularly advantageous image presentation and/or may facilitate the analysis. The distribution may for example be represented by a histogram. The distribution may first be determined in one or more image segments. The individual distributions may then be combined into a combined distribution with the pixel value distribution characteristic being determined as a characteristic of the combined distribution.

As another example, a characteristic may be determined for each segment distribution and the characteristics may then be combined. For example, the pixel value variance for each segment may be calculated and used to determine an average pixel value variance.

In accordance with an optional feature of the invention, the analyzing means is arranged to perform a coding artifact analysis on at least the first region and to generate the pixel value spatial variation characteristic in response to a coding artifact characteristic.

This may provide improved performance in many scenarios. The decoding artifact characteristic may be used to compensate another characteristic, such as the spatial frequency characteristic, and/or may be used directly to adapt the scaling. Specifically, the pixel value spatial variation characteristic may comprise the coding artifact characteristic.

In accordance with an optional feature of the invention, the analyzing means is arranged to perform a motion analysis on at least the first region and to generate the pixel value spatial variation characteristic to comprise a motion characteristic.

This may provide an improved image presentation in many scenarios. The motion characteristic may specifically be a motion characteristic of one or more image objects.

In accordance with an optional feature of the invention, the display apparatus further comprises for performing a content analysis on at least the first region and wherein the scaling means is arranged to scale the second region in response to a content characteristic.

This may provide an improved image presentation in many scenarios. The content analysis may specifically determine a content category for the image and the scaling may be modified in accordance with a predetermined bias for that content category.

In accordance with an optional feature of the invention, the scaling comprises cropping.

This may provide an improved image presentation in many scenarios. The cropping may specifically be performed when the image variation characteristic meets a criterion. The selection of which part to crop or retain may depend on the local spatial characteristics of the image.

In accordance with an optional feature of the invention, the scaling is further dependent on a characteristic of a display window available for displaying the scaled image.

This may provide improved image presentation in many embodiments. The characteristic of the display window available for displaying the scaled image may specifically be a size of the display window. This approach may be particularly advantageous in embodiments where the potential maximum display window may vary. For example, it may be highly advantageous in embodiments wherein the display is projected on different surfaces (wall, door, windscreen etc) that cannot be predicted in advance.

In accordance with an optional feature of the invention, the scaling comprises resolution scaling to a resolution corresponding to a desired window size, which may typically be non linear.

This may allow improved and/or facilitated implementation and/or advantageous performance in many embodiments.

In accordance with an optional feature of the invention, the analyzing means is arranged to determine an image object spatial profile characteristic for at least one image object (i.e. look at how the pixel values vary across the object, which object may result from segmentation, or object detection, etc.), and the scaling means is arranged to perform the scaling in response to the object spatial profile characteristic.

This may provide advantageous image presentation and/or performance in many embodiments.

In accordance with an optional feature of the invention, the image is an image of a video sequence of images and the analyzing means is arranged to perform a temporal analysis on the video sequence to generate a temporal pixel value variation characteristic, and wherein the scaling means is arranged to scale the second region in response to the temporal pixel value variation characteristic (e.g. static scenes may be shown larger than hectic scenes, with complex motion).

This may provide advantageous image presentation and/or performance in many embodiments. In particular, it may allow temporal noise to be determined and may allow the scaling to further be optimized for this noise. The temporal pixel value variation characteristic may be used to compensate another characteristic, such as the spatial frequency characteristic, and/or may be used directly to adapt the scaling. The temporal pixel value variation characteristic may specifically be a temporal pixel noise characteristic.

In accordance with an optional feature of the invention, the presentation means is arranged to present the image in a sub-window of a display window, and the apparatus further comprises means for presenting another image in another sub-window of the display window.

This may provide advantageous image presentation and/or performance in many embodiments. In particular, it may provide an improved user experience and may allow a flexible and dynamic presentation of various information to a user.

According to an aspect of the invention there is provided a method of presenting an image, the method comprising: receiving an image to be displayed; performing a local image profile analysis on at least a first region of the image to determine a pixel value spatial variation characteristic; scaling at least a second region of the image in response to the pixel value spatial variation characteristic; and presenting the scaled image.

The optimal scaling will typically be done close to the actual display, however it could also be done on a remote server etc. The image processing device may store the signal in a memory (e.g. IC, optical disk, . . . ) for later use, or (possibly after special encoding taking into account abnormal sizes or aspect ratios (or dividing it into different signals for several display means), such as with auxiliary signals for supplementing a main cutout) send the signal over a network, etc. Each and every function of the possible displays according to this invention may typically be performed in a (part of) an IC or other image processing device (e.g. software on generic processor).

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a display system in accordance with some embodiments of the invention;

FIG. 2 is an illustration of an example of a displaying of images in accordance with some embodiments of the invention;

FIG. 3 is an illustration of an example of a display system in accordance with some embodiments of the invention; and

FIG. 4 is an illustration of an example of a displaying of images in accordance with some embodiments of the invention.

FIG. 5 shows a couple of exemplary scenarios of the general principle of optimal visual quality producing scaling.

### DETAILED DESCRIPTION OF SOME EMBODIMENTS OF THE INVENTION

The following description focuses on embodiments of the invention applicable to a display system and in particular to a display system for displaying an image on a display panel or projecting an image on a surface. However, it will be appreciated that the invention is not limited to such applications.

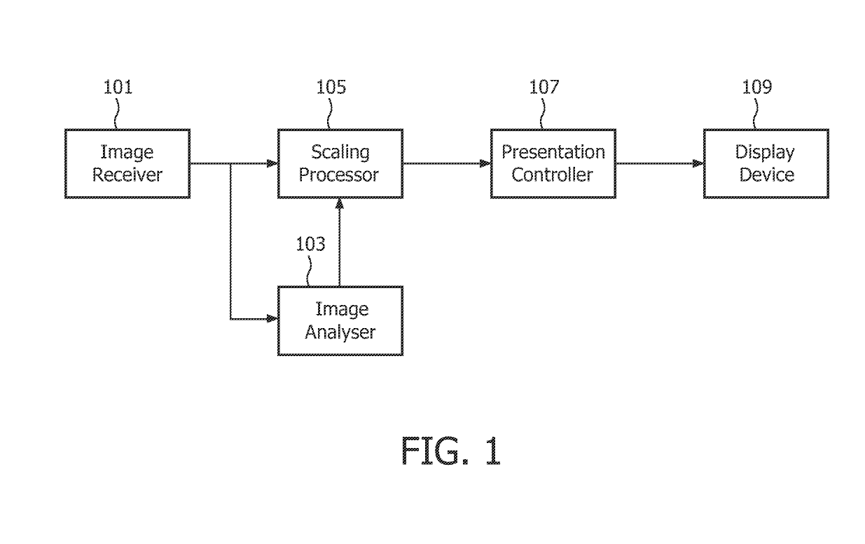

FIG. 1 illustrates an example of a display apparatus for presenting one or more images.

The display apparatus comprises an image receiver 101 which receives one or more images to be displayed. In the specific example, the image receiver 101 receives a video signal comprising a sequence of images (e.g. with each image corresponding to a frame of the video signal).

It will be appreciated that the image receiver 101 may receive the image from any suitable source which may be an internal or external source. For example, the video/image signal may be locally stored or generated in the display apparatus or may be received from an external source.

In the example, the display system may receive a large variety of different signals including SD, HD and QD video signals, low resolution and quality (very low data rate) video sequences, high resolution pictures etc.

The image receiver 101 is coupled to an image analyzer 103 and a scaling processor 105. The image analyzer 103 is further coupled to the scaling processor 105.

The image analyzer 103 is arranged to perform a local image profile analysis on at least a first region (this may be e.g. 20 N×M pixel blocks uniformly or content-based non-uniformly scattered over the image; the resulting characteristic may typically be an average e.g. sharpness, but it may also be a more complex multidimensional description) of the image in order to determine a pixel value spatial variation characteristic. The pixel value spatial variation characteristic is then fed to the scaling processor 105 which proceeds to scale at least one region of the image in response to the pixel value spatial variation characteristic. The region which is scaled may be the same as the region on which the pixel value spatial variation characteristic is determined but need not be so. Furthermore, the region being analyzed and/or the region being scaled may correspond to the entire image area of the image being processed.

The scaling processor 105 is coupled to a presentation controller 107 which is arranged to present the scaled image received from the scaling processor 105. In the specific example, the presentation controller 107 is coupled to a display device 109 (which may be external to the display apparatus) and generates a suitable drive signal for the display device. For example, the display device 109 may be a very large display panel, such as a 60″ or larger LCD or plasma display panel. The presentation controller 107 may then generate a suitable display signal for the display panel. As another example, the display device 109 may be a projector which is capable of projecting an image on an external surface, such as a wall or a reflective screen or (a part of) an object, and the presentation controller 107 may generate a suitable drive signal for the projector.

In the example, the display device 109 is arranged to display a large size picture. For example, the display device may be a display with a diagonal of several meters or more or may be projector intended to project an image with a diagonal of several meters or more.

As mentioned, the display apparatus is arranged to receive content from a variety of different sources and with varying characteristics. In particular, content with varying resolutions and varying image quality may be received. For example, the display apparatus may receive originally generated QD or HD content. HD content generated by upscaling, SD content, low quality video sequences (e.g. from mobile phones) high resolution photos, text based image content with different font sizes and text amount etc.

Thus, not only may the resolution of the received content vary greatly but the characteristics of the image content may also vary even for the same resolution. For example, different signals may be received with a resolution of, say, 1440×720 pixels but with very difficult content characteristics. For example, one signal at this HD resolution may be received from an HD signal source that has directly generated the content at this resolution. If the display device 109 is a panel display with a suitable size and resolution (e.g. a native resolution of 1440×720), this image will be presented with a high quality and will appear very clear and crisp. However, in other scenarios, the signal may be generated by upscaling an SD signal. Although such upscaling may provide acceptable results in many scenarios, the upscaling process is not ideal and may further introduce noise and artifacts. Accordingly, the presented image will be of reduced quality and will appear as such to the viewer even though it is upscaled to the same resolution. As a third example, the 1440×720 signal may originate from a very low resolution original signal (e.g. a video captured by a mobile phone with a resolution of, say, 352×288). In such a scenario, the image quality of the upscaled 1440×720 signal will be relatively low and will present a clearly suboptimal image to the viewer.

The impact of such quality variations is particularly problematic at large display sizes. For example, presenting a low source-quality image on a 60″ television or on a several square meter projected display area will result in the image being perceived to be of low quality and will typically appear to not only be noisy but also to be unsharp and blurred. This will be the case despite the image being upscaled to a higher resolution.

This impression of a lack of sharpness predominantly arises from the frequency content of the displayed image being far below the maximum resolution that the human eye can resolve (and usually below the frequencies that should be visible for the displayed object). This maximum resolution is around 30 cycles per degree, which means that when standing close by a large screen display, and looking with a viewing angle of 60 degrees at least 1800 cycles or 3600 pixels are required for optimal sharpness perception. However, the lower frequency source images (e.g. the original SD or low resolution image) contain far too few pixels for providing such sharpness. Furthermore, even resolution upscaling using state of the art techniques are typically unable to provide a sufficient high resolvable pixel resolution and the upscaled images are therefore often perceived as blurry. In addition, upscaling may introduce noise and artifacts that are perceptible in the presented image.

Indeed, upscaling techniques create samples (pixels) at intermediate locations between the existing samples. The created samples have a certain correlation to the original pixels and are therefore not providing the same sharpness information as a source signal at the higher resolution. Furthermore, when noise is present in the original image, the generated additional pixels tend to become more correlated thereby further reducing the sharpness perception. In addition, the noise in the original signal is now extended to a plurality of pixels and are therefore displayed as larger noise entities (due to the upscaling and displaying on a larger screen size), and therefore become more visible.

Thus, whereas the presented image for an input material of sufficient quality, e.g. an original HD source signal, will appear sharp and crisp, the presented images for source material of lower quality will be perceived to be of substantially lower quality and may indeed be perceived to be of unacceptable quality (even if high quality upscaling has been applied).

The inventors have realized that the perceptual quality is highest when the frequency content of the displayed image is close to (or even higher) than the maximum resolvable resolution of the human eye. Indeed, the inventors have realized that rather than merely presenting an image with characteristics dependent on the display system or the resolution of the image, it can be advantageous to scale at least some of the image depending on local pixel value spatial variations in the image. Indeed, such an approach may be used to directly control the spatial frequencies and thus sharpness of the presented images.

Thus, in the system of FIG. 1, the image analyzer 103 may perform a local image profile analysis on e.g. the whole image to characterize the pixel value variations. For example, for a HD signal originating from an original HD content, it is likely that the local pixel value variations may be very substantial (sharp) at some places (e.g. corresponding to sharp edges). This sharpness may be reflected by a high local variability in various neighborhoods (e.g. within an area of say N pixel diameter both very light and very dark pixels can be found at least some places in the picture). Specifically, the spatial frequency content of the pixel values may cover most of the available spectrum (for the spatial sample frequency (corresponding to the resolution)). However, for signals of the same resolution but with lower image qualities (e.g. due to upscaling of lower resolution original images), such values/characteristics are likely to be substantially lower as the edges a less sharp and the pixel variations are less. Thus, the image analyzer 103 performs an image analysis to determine a pixel value spatial variation characteristic that may specifically include one more of the above mentioned values. The analysis may take into account such factors as viewing geometry (how far is the viewer from the display), and viewer preferences (some viewers like the blurry look of pictures, whereas others are critical), in which latter case the scaler will typically have access to a memory storing the viewer preferences, or a realtime user input means.

The pixel value spatial variation characteristic is then fed to the scaling processor 105 which proceeds to scale the received image in dependence on the pixel value spatial variation characteristic. The scaling may for example be a simple adjustment of the size of the image when being presented.

For example, if the display device 109 is a projector, the scaling processor 105 may simply scale the signal by adjusting the size at which it will be displayed. This may e.g. be achieved by controlling the optics of the projector such that the image is enlarged or reduced. This may effectively correspond to changing the pixel size of the presented image.

As another example, resolution scaling may be applied. For example, if the projector has a resolution of 1920×1080 pixels and is arranged to display a full resolution image in a corresponding display window of, say, 3 m by 1.7 m, the scaling processor 105 may modify the resolution of the image to correspond to a smaller size depending on the pixel value spatial variation characteristic.

For example, for a high quality signal (e.g. the pixel value spatial variation characteristic indicating a high variation), the scaling processor 105 may use the full available resolution, i.e. the 1920×1080 pixels. However, for a low quality signal (e.g. the pixel value spatial variation characteristic indicating a low variation), the scaling processor 105 may only use a sub-window of the full available resolution. For example, for a low quality signal, the scaling processor 105 may generate an image with a resolution of 480×270 and position in the center of the full 1920×1080 image. Accordingly the projector will only present the image in a window size of 75 cm by 42 cm. However, at this lower display size the image will be perceived to be of relatively higher quality. Specifically, noise and artifacts are scaled to be less perceptible thereby compensating for the likelihood of these being more prevalent. Furthermore, the resolution of the presented image will be much closer to (or even above) the maximum resolution that the human eye can resolve and accordingly the image will be perceived to be substantially sharper.

It will be appreciated that the exact same approach may be used e.g. for a 3 m by 1.7 m sized display panel with a corresponding 1920×1080 resolution.

In the specific example above, the scaling processor 105 performs resolution scaling to a resolution that corresponds to a desired window size. Thus, in the example, the output signal from the scaling processor 105 has a fixed resolution corresponding to the full display window (e.g. full projected area or full resolution of large size display). The scaling processor 105 then proceeds to perform scaling of an input image (e.g. of a video signal) to result in an image having a resolution that will give the desired display window size when presented by the display device.

This resolution scaling may include an upscaling from a lower resolution (e.g. an SD resolution) to a higher resolution that corresponds to a specific display window. This upscaling may include the use of advanced upscaling techniques as will be known to the skilled person. However, it will be appreciated that the resolution scaling may also include a down scaling, for example if the desired window size corresponds to an image resolution that is lower than the resolution of the received image. Also, in some embodiments, the received image signal may already be at a resolution corresponding to the resolution of the display device and accordingly the scaling of the scaling processor 105 may either be no change or be a down-scaling.

It will also be appreciated that the scaling process may not simply correspond to a direct rescaling of the input image but may apply very advanced localized and flexible scaling approaches. Also, the scaling may not be applied to the whole image but may be applied to one or more regions of the image. Indeed, the scaling processor 105 may adjust the size of the presented image by cropping the image in dependence on the pixel value spatial variation characteristic.

As an example, the scaling process may include an image analysis identifying foreground image objects and a background. The background may then be upscaled to the desired window size while the image object is maintained at the same resolution and inserted in the upscaled background.

Indeed, it will be appreciated that scaling may include any process or algorithm that affects the size of the image when displayed by the display device 109. For example, for a projector, the scaling processor 105 may not modify the image in any way and may always provide the unmodified image signal to the presentation controller 105. However, in addition, the scaling processor 105 may generate a control signal which is fed to the optics of the projector. The control signal may then control the optics to provide a displayed image of the appropriate size.

Thus, the display system of FIG. 1 automatically adapts the display window in which the image (or part of the image) is displayed in dependence on the pixel value spatial variation characteristic. As the pixel value spatial variation characteristic may be indicative of the quality or sharpness of the image content, this allows an automatic adaptation of the presented image to provide an improved user experience and an improved perception of quality.

In some embodiments, the image receiver 101 may comprise a prescaler which may perform a prescaling of the input signal. For example, the input image may be prescaled by a fixed factor (e.g. it may be upscaled by a predetermined upscale process, such as a 4 times linear upscaler). This may e.g. be appropriate when the input signal is an SD signal (or lower) and the display is a QD display. Thus, the image receiver 101 may apply a prescaling which immediately upscales the image to a resolution closer to that which corresponds to a full display window size. The image analyzer may then process the prescaled image in order to determine the pixel value spatial variation characteristic, e.g. by evaluating the spatial frequency components. If the result is considered acceptable, the prescaled image may be used directly. However, if the high frequency content is too low (indicating that the image will appear unsharp), the scaling processor 105 further scales the prescaled signal. In particular, the scaling processor 105 may typically downscale the prescaled image to a lower resolution.

Indeed, in some scenarios, the scaling processor 105 may be used as a prescaler. E.g. it may first perform a predetermined scaling to generate a first scaled image. This image may then be analyzed by the image analyzer 103 to generate a pixel value spatial variation characteristic. Based on the pixel value spatial variation characteristic, a second scaling may be applied to the image (either to the original image or to the prescaled signal). The resulting scaled signal may then be analyzed. Such a process may e.g. be iterated until a stop criterion is met (e.g. that the pixel value spatial variation characteristic meets a criterion indicating that the perceived image quality will be acceptable).

In some embodiments, the prescaler may apply an adaptable prescaling to the input image such that this is scaled to a predetermined or fixed resolution. For example, all input images may first be upscaled to the full resolution of the display device 109. The resulting image is then analyzed by the image analyzer 103. If this results in an acceptable pixel value spatial variation characteristic (according to any suitable criterion), the prescaled image may be fed to the presentation processor 107. Otherwise, the scaling processor 105 may perform a downscaling of the prescaled signal to result in a reduced size display window.

In some embodiments, the scaling processor 105 may in such cases operate on the original image rather than the prescaled image, i.e. an upscaling with a scale factor less than the prescaling may be applied. Such an example may correspond to the prescaler being part of the image analyzer 103.

In some embodiments, the image analyzer 103 may specifically be arranged to perform a spatial frequency analysis of local spatial frequencies on at least one region of the image. Based on the frequency analysis, the pixel value spatial variation characteristic is then generated to comprise (consist in) a spatial frequency characteristic.

The frequency characteristic may specifically be an indication of the spatial frequencies that will result from the image being displayed within the full window available to the display device. Indeed, in some embodiments, the scaling may be adapted such that a given frequency characteristic for the displayed image is maintained relatively constant for varying frequency characteristics of the input signal. For example, the scaling processor 105 may scale the image such that e.g. a maximum frequency of the output signal being fed to the presentation controller is substantially constant.

In the example, the image analyzer 103 analyses the input image to determine a frequency characteristic. The frequency characteristic may specifically represent a frequency distribution characteristic and/or a frequency content characteristic of the image received from the image receiver 101. The frequency characteristics may represent spatial frequency content relative to the spatial sampling frequency (e.g. the resolution).

Specifically, the image analyzer 103 may convert the received image to the frequency domain, for example using a two dimensional Fast Fourier Transform (FFT). It may then evaluate the resulting frequency distribution to generate a suitable frequency characteristic. For example, the frequency characteristics may be generated to indicate a highest spatial frequency or e.g. the frequency corresponding to the 95^{th} percentile. This frequency will be given as a fraction of the sample frequency and may e.g. be scaled to a value between 0-1. Thus, a value of 1 may be used to indicate that the highest frequency (or the 95^{th} percentile frequency) is the same as half the spatial sample frequency and a value of 0 may be used to represent that the image only contains a zero frequency (i.e. it is just a single colour/shade). A high value is thus indicative of a high degree of high frequency components which indicative of a high degree of sharpness and especially of sharp transients being present in the image, whereas a low value is indicative of a lack of high frequency components and this of a low degree of sharpness (as the transitions do not exploit the full resolution available in the input image).

Typically, a frequency domain transformation of the entire image is computationally very expensive and therefore less demanding approaches may be used. For example, the image analyzer 103 may detect specific image areas or regions in which the analysis is performed. The image analyzer 103 may for example include an edge detector and specifically apply the frequency analysis to one or more regions around such detected edges.

As another example, encoded digital signals typically provide frequency domain representations of individual blocks (such as 8×8 pixel blocks). Thus, an encoded image signal may directly provide a frequency domain representation of each 8×8 block and the image analyzer 103 may extract these frequency domain values. It may then proceed to generate a histogram over the frequency values for the individual blocks resulting in a frequency distribution for the image represented by 64 frequency bins with a value for each bin representing the relative strength of frequencies within the frequency interval covered by the bin. Thus, for a low quality, blurred and unsharp image, it is likely that there is a high concentration at lower frequencies with no or relatively low strength at higher frequencies. However, for higher quality and sharper images, it is likely that the entire frequency range is used.

In the example, the scaling processor 105 then proceeds to scale the image such that it will provide a displayed image that has a suitable frequency content. In some embodiments, the relation between the size of the image being output from the scaling processor 105 and the displayed image may be known. For example, for a display of 3 m by 1.7 m sized display panel with a 1920×1080 resolution, each pixel will have a size of 0.15 cm by 0.15 cm. A nominal viewing distance may be assumed allowing a desired frequency of the output signal of the scaling processor 105 corresponding to the maximum frequency of the eye to be resolved. Thus, for the output signal of the scaling processor 105 a desired, say, 95% or maximum frequency relative to the sample rate of the signal may be known. If the frequency characteristic indicates that a full scale signal will be sufficiently close to this frequency, the output image will be generated to use the full available display window.

However, if the frequency characteristic indicates that the image only has a frequency which is half the desired frequency, this is compensated by scaling the signal. Indeed, in the example, the horizontal and vertical dimensions of the display may be reduced by a factor of two resulting in the displayed image having the same relative sharpness but being much smaller.

Thus, as an example, the scaling processor 105 may be arranged to scale the image such that the scaled image has a pixel value spatial variation characteristic and specifically a frequency characteristics that meets a criterion. Thus, different images will be scaled such that the scaled image meets a perceived quality criterion. Thus, the quality may be kept relatively constant with the size of the displayed image being modified.

It will be appreciated that other and more complex approaches for setting a characteristic of the scaling based on the pixel value spatial variation characteristic may be used. For example, a complex mathematical relationship between size and variation characteristic may be used and/or the scaling processor 105 may implement a look-up table that correlates the size and the variation characteristic. Such functions or look-up tables may furthermore be configurable allowing a user to adapt the operation to the specific display scenario. E.g. the function or values may be adjusted to reflect a distance between a projector and the display surface and/or between the display surface and the viewer.

In some embodiments, the image analyzer 103 is arranged to perform a sharpness analysis and to generate the pixel value spatial variation characteristic to comprise a sharpness characteristic. It will be appreciated that the previously described frequency analysis is an example of a sharpness evaluation and that the frequency characteristic is indeed indicative of a perceived sharpness. Indeed, higher frequencies are indicative of faster transitions and thus of increased sharpness.

However, other sharpness evaluations may alternatively or additionally be performed. For example, the image analyzer 103 may detect edges and specifically evaluate characteristics of such edges. For example, the rate of transition may be determined and averaged for all identified edges. Depending on the edge gradient (dx/dy where x represents the pixel value and y represents a spatial image dimension) the selection processor 205 may select different scalings. Thus, low gradients (corresponding to blurred/soft edges) may result in a small display window and high gradients may result in larger window sizes.

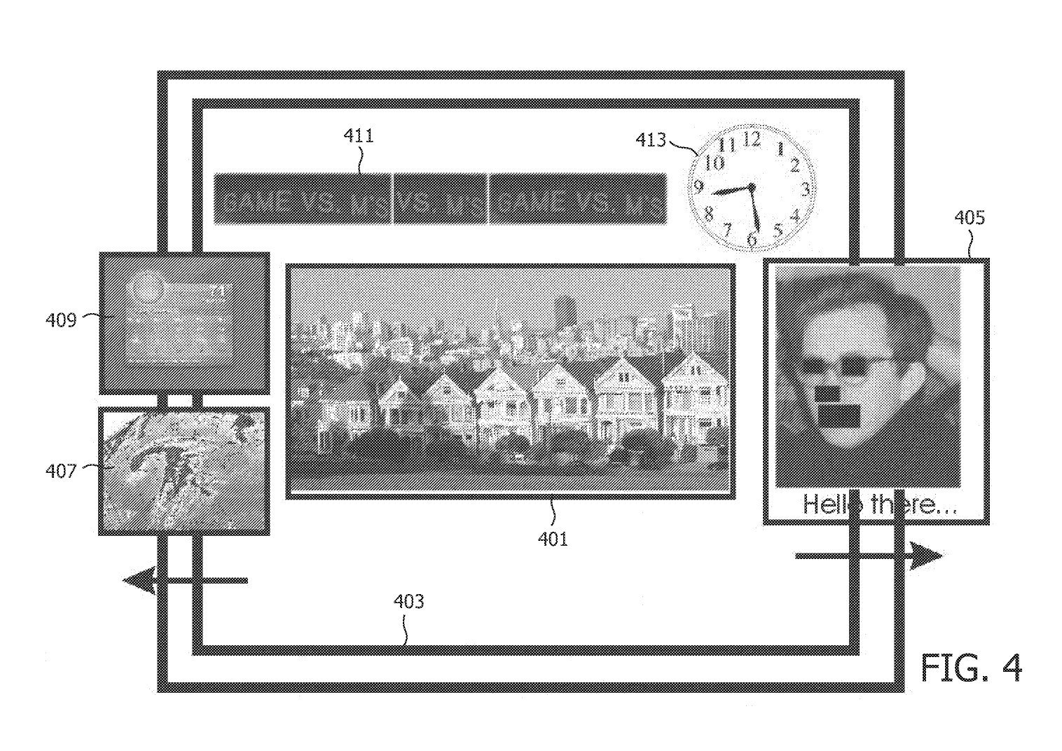

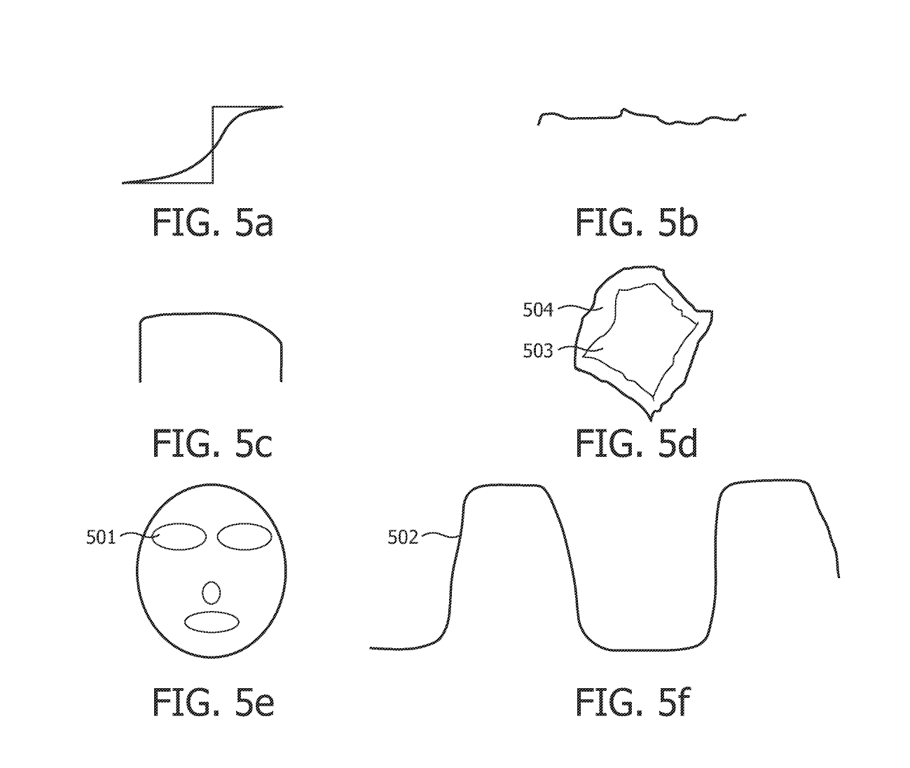

FIG. 5 shows a couple of more examples of the generic approach of looking at sharpness or frequency content. One would then typically look at signal complexity. FIG. 5a shows an easy to scale profile, namely a sharp inter-object edge. Linear scaling typically blurs this edge until it becomes unacceptable, non-linear scaling can mitigate this. FIG. 5b is an example of a profile which may at certain instances be very scalable too, namely a near constant pixel value profile. This may occur e.g. as the sky in between trees. In that scenario the sky actually is undetailed, and will be so in different scales. So a local patch of sky may be stretched or compressed almost arbitrary (where this may be undesirable in a movie, it may be a good scenario for aggressively scaling some of the side windows of FIG. 4). The same would apply to simple repetitive textures like e.g. a graphical brick pattern.

FIG. 5c is a microprofile of a texture comprising of hairs (each hair having a variable illumination profile), whereas FIG. 5d is a basic texture element of a net texture, which is composed of small sharp edges 504, and a near constant interior 503. Whereas the net texture may be easily scalable with a good non-linear scaler (because on large size the interior may also be constant, and the thin edges may be kept relatively thin), the hairs may not scale well with another used scaler, due to both having blurred edges, and an incorrect interior (typically lacking a realistic pixel variation profile, usually micro-detail). If however the hairs look good enough on the original size, another scaler can be used (like the method of Damkat EP08156628) which retains the same information complexity after scaling.

Information complexity typically has to do with different scales, such as object boundaries, and the pixel variations inside (compare to blurry interiors of bad compression). One typically has to look at the detail for these different local image parts, and judge whether that would be natural/possible or not (contrasting with the net texture or between-trees examples, an undetailed region in a badly compressed object—e.g. missing grass texture—would not scale well). E.g. the face object of FIG. 5e may become very cartoonish if there is insufficient detail in the areas 501 (instead of an eye texture there may just be a shadowy blob, which doesn't upscale well). Such an analysis of cross and interpattern complexity can employ various mathematical functions, like e.g. a normalized integral of pixel variations (e.g. a complex weighed and nonlinearly transformed variant of a sum of absolute differences of the present pixel value and the previous one). Texture analysis may look at the size of the grains and then the complexity of the interiors. FIG. 5f shows another example of generically looking at the frequencies rather than looking exactly at the values of the different FFT bins. It indicates that an object region may be too cartoony because there are long runs of pixel values 502 which do not have enough pixel variation. Depending on the chosen scaling algorithm (linear interpolation, fractal, texture-based graphical, . . . ) some scalings may be determined as of good enough quality whereas other won't meaning the picture has to be displayed smaller.

It will be appreciated that the described approach can be used in many applications and embodiments.

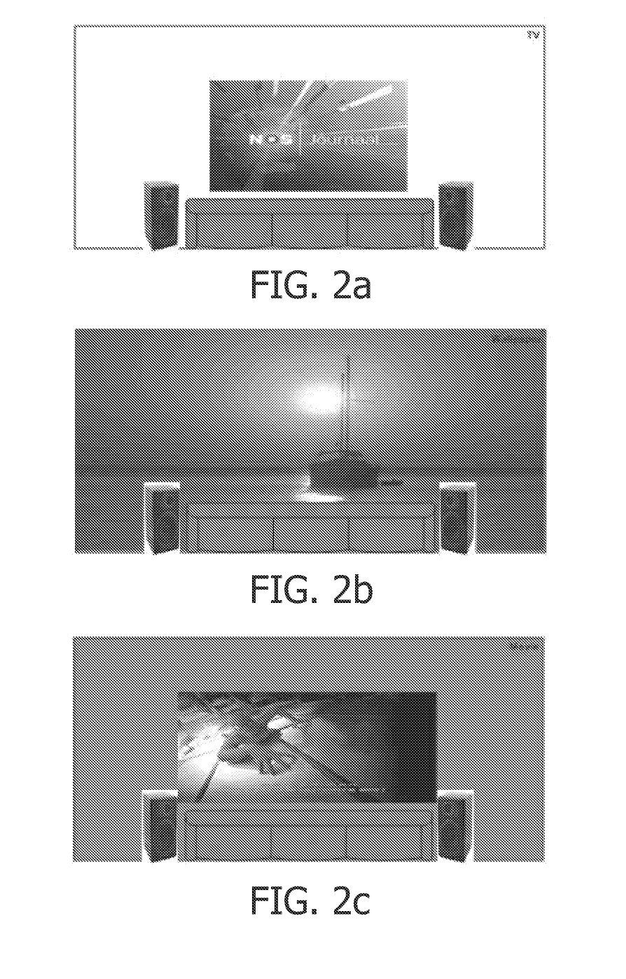

For example, the display device 109 may be a projector which can present a display on a wall of a room, such as living room. Such an example is illustrated in FIG. 2 where the projector may display the image to cover an entire wall, i.e. the maximum display window corresponds to a full wall. The projector may specifically be a high resolution projector, having e.g. a resolution of 1920×1080 pixels. The display apparatus of FIG. 1 may be used to display different image signals on the wall.

For example, the input signal may originate from a conventional television signal that provides a standard SD video signal. The SD video signal may be upscaled to a HD resolution (e.g. by the display apparatus or prior to being provided to the display apparatus) but this will typically result in a signal of reasonable but not extremely high quality. Therefore, the analysis by the image analyzer 103 will indicate e.g. a frequency content which does not fully exploit the available spatial frequency range. Accordingly, the scaling processor 105 will scale the signal such that an image of a reasonable size is provided (ref. FIG. 2a). This size is specifically optimized to provide a desired trade-off between perceived quality and image size.

However, at other times, the display apparatus may be used to present a high resolution still image. The image may e.g. be provided directly in the resolution of 1920×1080 pixels. This image will typically fully utilize the available resolution and may have frequency content that represents the full available frequency range. Accordingly, the scaling processor 105 will scale the image such that it is displayed in the full window, i.e. such that it covers the entire wall (ref. FIG. 2b).

At other times the display system may be used to watch a movie originating as a HD density movie at a resolution of 1440×720. Again, this content may be upscaled to the native resolution of the display system of 1920×1080 pixels. However, due to the improved quality of the original signal, the sharpness of the upscaled image is likely to be significantly better than for the SD signal but not as high as the high resolution photo. This will be reflected in the frequency characteristic generated by the image analyzer 103 and accordingly the display system can scale the signal to present the content in a display window which is in between the size used for the television signal and the size used for the high resolution photo (ref. FIG. 2c).

Thus, in these three examples, the image receiver 101 may receive three different signals that are all at the same resolution of 1920×1080 pixels. However, as they originate from very different signals, the actual image quality or sharpness of the actual image varies significantly within this fixed resolution frame work. In the example, the display system can detect this automatically and can adjust the size of the presented image to provide the optimized trade-off between the perceived quality and the image size. Furthermore, this optimization may be performed automatically.

As another example, the display apparatus may be implemented as part of a portable device that can be fed a variety of signals and which can be used in different applications. For example, a user may enter a distance to the display surface on which the image is projected and a distance of a viewer. The portable projector may then be arranged to automatically calculate and apply the scaling for different image qualities.

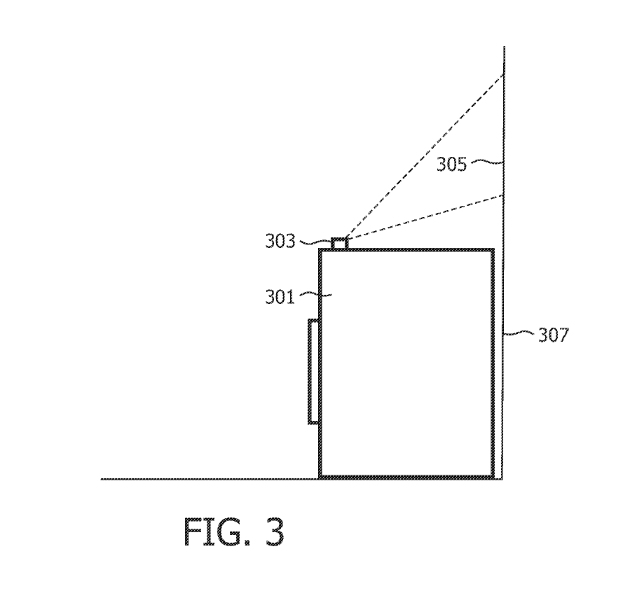

As another example, the display system may be used as part of a consumer device or appliance to present additional information or instructions. For example, as illustrated in FIG. 3, a washing machine 301 may comprise a projector 303 that can project an image 305 on a wall 307 behind and above the washing machine 301.

The system may for example be used to present a context sensitive instruction manual or decision tree to the user. Thus, the washing machine 301 may have a range of images that can be presented to assist the user. These images may predominantly comprise text based information but may also comprise images or pictograms. The images may all be stored at the same resolution but may vary substantially, i.e. some images may contain a small amount of large font text, others may contain simple images, yet others may contain large amounts of small font text etc.

In the approach, the display apparatus may evaluate each image that is displayed to determine the sharpness or frequency content and may scale the image accordingly. For example, a page/image containing a large amount of text may be presented as a relatively large picture 305 on the wall 307. However, a page/image containing a small amount of text may be presented as a relatively small picture 305 on the wall 307. Thus, the system may automatically adapt the image size to match the content of the specific image/page. For example, the size of the image may automatically be adapted to provide a substantially equal font size but with varying image sizes. It should be noted that this may be achieved without changing the resolution of the projected image, e.g. by the scaling processor 105 directly controlling the optics of the projector.

As mentioned previously, the scaling processor 105 may in some embodiments or scenarios not merely resize the image but may alternatively or additionally select one or more regions of the image. For example, the scaling processor 105 may be arranged to crop the image in certain scenarios. For example, the frequency analysis may indicate that the image should be presented in a display window which is larger than the display window which is available to the display apparatus. In this case, the scaling processor 105 may proceed to resize the image to the desired size (e.g. one that corresponds to an appropriate frequency content of the displayed image) and to crop the resulting image to the size of the available display window.

E.g. in the washing machine example, some pages/images may have small amounts of large font text and this may be scaled to be presented in a window which is smaller than the full display window. Other pages/images may have larger amounts of smaller font text that are still possible to be viewed when presented in the maximum display window. However, yet again, other pages may comprise large amounts of text written with a small font. Thus, these pages have a very high concentration of high frequencies indicating that there is a lot of detail in the picture. Indeed, the scaling processor 105 may evaluate that even if the image is presented in the maximum display window, it will not be sufficient to provide a sufficiently legible text to the user. Accordingly, the scaling processor 105 may not only re-size but may also crop the image. Thus, the image may be scaled by a cropping which is dependent on the frequency characteristic. In particular, the scaling may comprise cropping when the pixel value spatial variation characteristic meets a criterion.

It will also be apparent from this description that the scaling can be dependent on a characteristic of the display window which is available for displaying the scaled image. Thus, in the specific example, the image is cropped if it cannot be displayed appropriately within the maximum size of the potential display window.

In another example, the projector 303 of the washing machine 301 may project the image on a free surface of the washing machine itself For example, a flat white surface of the washing machine 301 may be used to display the image. However, in such an approach, the available surface may be strictly limited by the various visual features of the washing machine 301 and therefore only a relatively small surface area may be available therefore resulting in a frequent cropping.

As another example, the display system may be used in a vehicle such as a car. In this example, the display device 109 may comprise a projector which projects the image on the windscreen of the car. In this example, part of the windscreen may be kept clear for the driver whereas the image is projected on the passenger side of the windscreen. The size of the image is adjusted depending on the frequency/sharpness characteristic such that the image is no bigger than required or desired in view of the information content. However, in addition, the display system can also take into account how much of the windshield should be kept free for allowing the outside to be viewed, i.e. to ensure that the driver can see sufficient amounts of the traffic outside. Thus, a calculation of the image size may be performed as a function of the sharpness/frequency parameter as well as a second parameter indicating a potential display window.

It will be appreciated that an edge sharpness or frequency analysis are merely examples of the local image profile analysis that can be performed to determine the pixel value spatial variation characteristic. Indeed, any analysis which provides an indication of how much or how fast the pixel values vary spatially between pixels that are relatively close together can be used. Thus, the pixel value spatial variation characteristic does not merely indicate the spread of pixels in the image as a whole bur rather how they vary on a local scale. For example, an image wherein half of the image is very dark and the other half is very bright may have a large pixel value variation. However, the local pixel variation may be relatively low as there may be virtually no variations within each of the two halves (i.e. the variation occurs only on the edge). In contrast, an image with a lot of detail (e.g. a “busy” picture) will typically have a high local pixel value variation as the pixel values vary substantially even within local areas.

It will be appreciated that for an edge detection sharpness approach and a spatial frequency approach the local characteristic of the pixel variations are automatically taken into account. However, in other approaches the pixel variation analysis may be localized by analyzing pixel variations within image sections or regions. For example, the image may be separated into a number of segments or regions and the pixel variation within each segment or region may be evaluated. The pixel value spatial variation characteristic may then be generated by analyzing or combining the results for the different segments.

This approach may for example be used for embodiments wherein the pixel value spatial variation characteristic is determined in response to a pixel value distribution characteristic that reflects how pixel values are distributed.

For example, the pixel value may be a luminance value which can take on the values from 0 to 255. The image may be divided into a number of segments and for each segment a histogram is generated for the luminance value. The histogram is then used to generate a variance for the pixel value in each segment. The variances for the different segments may then be combined e.g. by determining an average variance for the segments. This average variance can then be used as the pixel value spatial variation characteristic.

Thus, in such an example, an image with a very bright half and a very dark half will result in a relatively low average variance as most segments will fall either within the bright half or the dark half and therefore have relatively low variance. However, for an image where there is a substantial amount of small details and fast luminance variations between neighboring pixels, most segments will have a relatively high variance thereby resulting in a high average variance for the picture as a whole. Thus, this average variance is indicative of the image containing a relatively high amount of local pixel variations thereby being indicative of a detailed image that can advantageously be presented in a relatively large display window.

In some embodiments, the image analyzer 103 may be arranged to perform a texture analysis on one or more regions. The pixel value spatial variation characteristic may then be determined in response to a texture characteristic. For example, the surface area of an image area may have a texture with substantial detail (e.g. texture grain profiles) and relatively sharp pixel value variations. This is indicative of a high degree of high frequency content and thus a sharp image that can be presented with a relatively large size. However, if the surface area is characterized by the texture being relatively smooth and having only small and gradual pixel variations, this is indicative of a low degree of high frequency content and therefore indicates that a small display window should be used.

Such a texture analysis may for example be performed as a local/patch based variance computation with binning into classes. For example, different textured image object surfaces may be identified. Each surface may be divided into a number of segments and for each segment the pixel values may be divided into bins of a histogram. The variance of the segment may then be determined. An average variance for all the textured surfaces may then be calculated and may be used to determine the texture characteristics to indicate a level of texture. For example, a low variance may indicate a flat surface/image (virtually no texture), a mid range variance may indicate that there is some limited texture, and a high variance may indicate that there is a high degree of texture.

In some embodiments, the image analyzer 103 may be arranged to perform a motion analysis of the picture. The pixel value spatial variation characteristic may then be generated in response to this motion characteristic.

In particular, if the image being processed is a frame of an encoded video signal such motion data may be directly available and can simply be derived by extracting the relevant motion data from the encoded bitstream. In other embodiments, a temporal analysis of plurality of frames may be performed to detect image objects and characterize their movement within the image. It would be appreciated that many such techniques will be known to the skilled person.

The size of the display window used for presenting the image may then be adjusted in dependence on the motion characteristic. For example, in some embodiments a high degree of motion may be indicative of a high degree of individual image objects moving fast within the image. This may be more suitable for a presentation in a relatively large display window in order to allow the user to discern and follow the individual image objects.

In some embodiments the image analyzer 103 is arranged to perform a decoding artifact analysis and to generate the pixel value spatial variation characteristic in response to the decoding artifact characteristic.

In many typical digital applications the image signal (whether a static or moving image) will be digitally encoded. For example a digital photo may be encoded in accordance with a JPEG encoding algorithm and a video signal may be encoded in accordance with an MPEG encoding algorithm.

However such encoding typically includes a substantial data compression and may result in a noticeable difference between the decoded signal and the original signal. Such differences may be considered coding artifacts and will be present in the decoded image. For example, for relatively high compression ratios, media signals may often experience a certain “blockyness” resulting from the encoding of the images being based on encoding of individual blocks.

In some embodiments, the image analyzer 105 may specifically be arranged to evaluate such coding artifacts. For example, the image analyzer 105 may divide the image into 8 x 8 pixel blocks corresponding to the coding blocks. It may then proceed to determine characteristics of pixel variations within the blocks compared to pixel variations between the blocks. If this analysis indicates that the pixel variations between blocks are relatively high compared to the pixel variations within the block, this is likely to be due to a relatively high degree of coding blocks artifacts (of “blockyness”).

The evaluation of coding artifacts may be used in different ways. In some scenarios it may be used directly as the pixel value spatial variation characteristic, i.e. it may directly be used to adjust the scaling of the image. This may allow the display window to be sized such that it matches the degree of encoding artifacts, i.e. such that these do not degrade the perceived quality too much. For example, if there is a high degree of coding artifacts, a smaller display window size may be used than if there is not a high degree of coding artifacts.

However, alternatively or additionally, the coding artifact may be used to modify the analysis of other parameters. For example, when performing a spatial frequency and analysis the image may first be compensated to reduce or remove coding artifacts. For example, is a large degree of coding artifacts are detected, the spatial frequency analysis may be limited to be performed within encoding blocks and to not extend between encoding blocks. This may allow the frequency analysis to represent the detail and sharpness of the underlying image without being unduly affected by the coding artifacts. Indeed in many scenarios coding artifacts may actually introduce additional high frequency spatial components which may be misconstrued as indications of increased sharpness. Therefore, the coding artifacts mitigation may prevent that a lower quality image is interpreted as being sharper than the corresponding image without coding artifacts.

Thus, in the example, the scaling may be dependent on the frequency characteristic determined after the coding artifact mitigation. However, in addition the scaling may also be dependent on the coding artifact analysis in itself. For example, a full display size may only be used if the frequency characteristic is indicative of a sufficient degree of high frequency components and if the coding artifact characteristic is indicative of an amount of coding artifacts being below a threshold. If any of these two criteria is not met, a lower display window size is used.

In some embodiments, the image analyzer 103 may be arranged to perform a content analysis on the image and the scaling means may be arranged to perform the scaling (at least partly) in response to the content characteristic.

The content analysis may specifically be arranged to determine a content category for the presented image and the scaling of the image may be dependent on the content category. The content analysis may for example include a scene detection that is able to characterize the specific scene displayed by the image. For example, it may detect whether the image is a landscape or oceanscape and if so it may modify the scaling to provide an image that is larger than it would otherwise be.

It will be appreciated that this content analysis may be applied to both still and moving images. For example, the display system may be arranged to detect that the presented material corresponds to a football match and may in response be arranged to bias the scaling according to a preference for football matches (for example the size of the display window may be increased).

It will be appreciated that in many such embodiments the content analysis is used to enhance the scaling based on the pixel value spatial variation characteristic. Indeed, the approach may allow a further adaptation of the display window to the user preferences. E.g. for a given level of sharpness and detail, the user may prefer different sizes of the presented image dependent on whether this is of a landscape or a football match.

In some embodiments, the image may be part of a video sequence of images, for example a sequence of video frames may be analyzed. In such an example, the image analyzer 105 may also be arranged to perform a temporal analysis to determine a temporal pixel value variation characteristic. For example, as previously described a motion characteristic for image objects may be determined.

As another example, temporal noise may be estimated based on an image analysis. Thus, whereas such noise may show up in the individual image and may be represented by the pixel value spatial variation characteristic, a temporal analysis may provide further information that can be used. For example, the temporal analysis may allow a differentiation between texture of an image object and noise in the image object. Thus, temporal noise may be estimated and used in a similar way as described for the coding artifacts. E.g. it may be used to compensate the pixel value spatial variation characteristic (in order to compensate for noise being interpreted as local high frequency variations) and may be used directly to determine the scaling (e.g. reducing the display window size when there are significant temporal noise in order to make this less perceptible).

In some embodiments, the image analyzer 105 may specifically perform the analysis based on one more image objects in the image. For example, a segmentation of the image may be performed to detect one more image objects. An image object spatial profile characteristic may then be generated for the specific image object. Specifically, one or more of the analyses described above may be applied directly to the extracted image object. The scaling may then be performed to provide the desired property of the specific image object. For example, the image size may be selected such that the image object is presented with a desired degree of sharpness, or with a size not above a threshold (above which the object may e.g. look unrealistic, intimidating, etc.).

The following description focused on the processing and evaluation of a single display window. However, it will be appreciated that in many embodiments the images may be presented simultaneously in other display windows (which may be overlapping display windows).

For example, in some embodiments any available display spaces that are not used by the main image may be used to present another image. Thus, the overall display area may be divided into a plurality of display windows which allow simultaneous presentation of several windows.

An example of such a scenario is shown in FIG. 4. In the example, a main window 401 is placed centrally in the display area 403. The display area may specifically correspond to (part of) a wall, or a top surface of a washing machine or any outer surface of an other (part of an) object, on which a projector projects a picture comprising the plurality of display windows.

In addition to the main window 401 there are a number of display windows 405-413 that simultaneously display other information. For example, one window 405 may be used as a video chat window, another window 407 may be used to provide a weather satellite image, another window 409 may be used to provide a static weather forecast, another window 411 may be used to provide information of upcoming events and another window 413 may be a graphical image used to indicate the current time. Thus, the display area may provide a “wall of information” that simultaneously presents different information to the user.

In the example, the previously described scaling may be applied to the image of the central display window 401 (the one selected as the main display window). In the example, the main display window 401 may accordingly adjust its size depending on the specific sharpness indication of the image. Thus, sometimes that main display window 401 may be relatively small and other times it may be relatively large.

In the example, one or more characteristics of the other windows 405-413 may further be dependent on the characteristic of the main window 401. For example, the auxiliary windows 405-413 may be positioned and sized such that they are displayed outside of the main display window 401. For example, when the main display window 401 is relatively large, the auxiliary display windows 405-413 are moved further towards the side of the display window. Furthermore, in some embodiments, the size of one or more of the auxiliary windows 405-413 may also be adjusted depending on the scaling that is applied to the main window 401 (so that they fall less outside the displayable area 403). For example, when the size of the main window 401 is reduced the corresponding size of the auxiliary windows 405-413 is increased correspondingly.

In some embodiments, the described adaptive scaling may alternatively or additionally be applied to one more of the auxiliary windows 405-413 (in that case the basic scaling algorithm is partly constrained, resulting in intermediate optimal scaling). For example, in some embodiments the main window 401 may have a fixed size whereas one or more of the auxiliary windows 405-413 is scaled according to a sharpness indication for that window 405-413. E.g. in the example of FIG. 4, this size of auxiliary window 405 may depend on the relative sharpness of the presented image of the person, or to render the face still realistic enough. E.g. if the image is relatively sharp (for example indicated by a high proportion of high frequency signal components), the size of the auxiliary window 405 may be set to the highest value that allows it to be presented within the display area 405 and outside the main window 401. However, if the relatively sharpness is low, the size of the auxiliary window 405 is reduced correspondingly thereby providing an improved perceived image quality. This may furthermore allow more or larger other extraordinary windows 407-413 to be presented simultaneously.

As a specific example, the auxiliary window 405 may in some examples be used to present images of people. The scaling of the window 405 may then be optimized to provide a display that provides an optimal sharpness for the person presented. Indeed, making the display too large will result in the recognition of the person being made more difficult as block artifacts and/or blurriness makes the image less easy to perceive by the user.

In the specific example, the approach described with reference to FIG. 1 is simultaneously applied to all display windows 401, 405-413. Thus, each individual window is optimized to be presented with the size that best matches the determined sharpness for that window. It will be appreciated that in some embodiments, the scaling of one window may further take into account the scaling/sharpness characteristic of other windows. For example, the optimal size may be determined for each individual window and consequently these sizes may be further modified to ensure that all windows can be fitted within the available display area 403. This may typically be done e.g. by allocating size budgets to the windows and defining an asymmetrically weighed cost function punishing deviation from the optimal sizes.

In other embodiments, the positioning of some or all of the auxiliary windows 405-413 may be modified such that they extend beyond the available display area 403. E.g., in the example of FIG. 4, auxiliary display windows 405-409 moved outwards such that only part of the windows 405-409 is visible. If the characteristics of the main window 401 changes resulting in the main window 401 reducing in size, the auxiliary display windows 405-409 may automatically slide back into the viewable display window 403.

Thus, the example of FIG. 4 may specifically provide an “elastic cloud” presentation of different information in different windows. Thus, it may provide a cloud of co-windows moving beyond the boundary of the displayable area depending on the optimization of the main display window.

The scaling of the individual windows may further depend on whether the window is selected as the main window or not. For example, for each window, one desired quality measure is stored for the scenario where this is selected as the main window and another is stored for the scenario where the window is selected as an auxiliary window. E.g. when a window is the main display window, it is controlled to provide an optimized perceived quality. However, when it is selected as an auxiliary window, it is only required that a minimum quality level is achieved while otherwise allowing a free adjustment of the window to allow it to optimally fit with the other presented windows.

It will also be appreciated that in the example where the auxiliary display windows 405-413 may automatically be moved partially out of the available display window 403, a selection of part of the image may be applied. For example, an adaptable cropping or image object extraction may be applied to provide an optimal image section within the visible display window 403.

If other display means are available, the scaling apparatus can take this into account by employing them in an appropriate way. E.g., a main picture after scaling falling outside the achievable geometry of a first display, may be partially represented on a second display (e.g. ambilight projects the outer picture regions (possible processed by image processing such as e.g. further non-linear stretching—or graphically adding extra objects/patterns e.g. trees etc.—to give the projection a more immersive character) as an environment on adjacent wall, or an adjacent second LCD display). In the case of multiple windows, some of the windows (e.g. if less than 50% of it would be visible on the main display area) may be offloaded to a second display (e.g. the weather picture could be switched to a display on the universal remote control, and the clock picture could be sent to a photoframe display on the cupboard).

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A display apparatus for presenting an image, the display apparatus comprising:
means (101) for receiving an image to be displayed;
analyzing means (103) for performing a local image profile analysis on at least a first region of the image to calculate a characteristic representing spatial variation of pixel values;
scaling means (105) for scaling at least a second region of the image in response to the characteristic representing spatial variation of pixel values; and
presentation means (107) for presenting the scaled image.

2. The display apparatus of claim 1 wherein the analyzing means (103) is arranged to perform a spatial frequency analysis of local spatial frequencies on at least the first region and to generate the characteristic representing spatial variation of pixel values comprising a spatial frequency characteristic.

3. The display apparatus of claim 1 wherein the analyzing means (103) is arranged to perform a sharpness analysis on at least the first region and to generate the characteristic representing spatial variation of pixel values comprising a sharpness characteristic.

4. The display apparatus of claim 1 wherein the analyzing means (103) is arranged to perform a texture analysis on at least the first region and to generate the characteristic representing spatial variation of pixel values comprising a texture characteristic.

5. The display apparatus of claim 1 wherein the analyzing means (103) is arranged to perform a pixel value distribution analysis on at least the first region and to generate the characteristic representing spatial variation of pixel values comprising a pixel value distribution characteristic.

6. The display apparatus of claim 1 wherein the analyzing means (103) is arranged to perform a coding artifact analysis on at least the first region and to generate the characteristic representing spatial variation of pixel values in response to a coding artifact characteristic.

7. The display apparatus of claim 1 wherein the analyzing means (103) is arranged to perform a motion analysis on at least the first region and to generate the characteristic representing spatial variation of pixel values to comprising a motion characteristic.

8. The display apparatus of claim 1 further comprising means (103) for performing a content analysis on at least the first region and wherein the scaling means (105) is arranged to scale the second region in response to a content characteristic.

9. The display apparatus of claim 1 wherein the scaling comprises cropping.

10. The display apparatus of claim 1 wherein the scaling is further dependent on a geometric characteristic of a display window available for displaying the scaled image.

11. The display apparatus of claim 1 wherein the scaling comprises resolution scaling to a resolution corresponding to a desired window size.

12. The display apparatus of claim 1 wherein the analyzing means (103) is arranged to determine an image object spatial profile characteristic for at least one image object, and the scaling means (105) is arranged to perform the scaling in response to the object spatial profile characteristic.

13. The display apparatus of claim 1 wherein the image is an image of a video sequence of images and the analyzing means (103) is arranged to perform a temporal analysis on the video sequence to generate a temporal pixel value variation characteristic, and wherein the scaling means (105) is arranged to scale the second region in response to the temporal pixel value variation characteristic.

14. The display apparatus of claim 1 wherein the presentation means (107) is arranged to present the image in a sub-window of a display window, and the apparatus further comprises means for presenting another image in another sub-window of the display window.

15. A method of presenting an image, the method comprising:
receiving an image to be displayed;
performing a local image profile analysis on at least a first region of the image to determine a characteristic representing spatial variation of pixel values;
scaling at least a second region of the image in response to the characteristic representing spatial variation of pixel values; and
presenting the scaled image.

16. An image processing device comprising:
means (101) for receiving an image to be displayed;
analyzing means (103) for performing a local image profile analysis on at least a first region of the image to calculate a characteristic representing spatial variation of pixel values;
scaling means (105) for scaling at least a second region of the image in response to the characteristic representing spatial variation of pixel values.
